(19) United States
(12) Patent Application Publication
(10) Pub. No.: US 2026/0128438 A1
(43) Pub. Date: May 7, 2026

(54) RUGGED BATTERY CONNECTOR SEAL WITH SHARK FIN PROFILE

(71) Applicant: MOTOROLA SOLUTIONS, INC., Chicago, IL (US)

(72) Inventors: Chun Wen Ooi, Georgetown (MY); Pedram Djavadkhani, Georgetown (MY); Khairul Azri bin Khairul Salleh, Bayan Lepas (MY); Ahmad IIman Mohd Masri, Sungai Jawi (MY)

(21) Appl. No.: 18/939,334

(22) Filed: Nov. 6, 2024

(51) Int. Cl. H01M 50/247; H01M 50/284

(52) U.S. Cl. CPC H01M 50/247; H01M 50/284; H01M 2220/30

(57) ABSTRACT

A battery connector seal for a portable communication device includes a first sealing rib, a second sealing rib extending from the first sealing rib, a third sealing rib extending from the second sealing rib, and a fourth sealing rib extending from the third sealing rib to the first sealing rib. The first sealing rib, the second sealing rib, the third sealing rib, and the fourth sealing rib together define a central opening. The first sealing rib, the second sealing rib, the third sealing rib, and the fourth sealing rib are positioned to receive a battery sliding across the third sealing rib toward the first sealing rib. The third sealing rib has a non-symmetrical cross-sectional profile.

### BACKGROUND

Portable radios commonly use a slide-in locking mechanism to releasably lock a battery in place along a housing of the portable radio. Portable radios also commonly include a battery connector seal along the housing. The battery slides across the battery connector seal when the battery is being attached or removed from the housing.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments, examples, aspects, and features of concepts that include the claimed subject matter, and to explain various principles and advantages of those embodiments, examples, aspects, and features.

FIG. 1 is a perspective, exploded view of a portable communication device according to one example, illustrating a housing and a battery.

FIG. 2 is a rear view of a portion of the portable communication device, illustrating a battery connector seal coupled to the housing.

FIG. 3 is a rear view of the battery connector seal.

FIG. 4 is a cross-sectional view of the battery connector seal, taken along lines 4-4 in FIG. 3.

FIG. 5 is an enlarged view of a portion of the cross-sectional view of FIG. 4, illustrating a sealing rib having a non-symmetrical cross-sectional profile.

FIG. 6 is an enlarged cross-sectional view of a sealing rib according to another example, having a non-symmetrical cross-sectional profile.

FIG. 7 is a cross sectional view of the portable communication device, taken along lines 7-7 in FIG. 2.

FIG. 8 is a schematic representation of the battery in a first position, sliding onto the housing of the portable communication device.

FIG. 9 is a schematic representation of the battery in a second position, sliding onto the housing of the portable communication device.

FIG. 10 is a schematic representation of the battery in a third position, sliding onto the housing of the portable communication device.

FIG. 11 is a schematic representation of the battery in a fourth position, sliding onto the housing of the portable communication device.

FIG. 12 is a cross-sectional view of the portable communication device, after the battery has been attached to the housing.

Skilled artisans will appreciate that elements in the figures are illustrated for simplicity and clarity and have not necessarily been drawn to scale. For example, the dimensions of some of the elements in the figures may be exaggerated relative to other elements to help improve understanding of the examples, aspects, and features presented in this disclosure.

The system, apparatus, and method components have been represented where appropriate by conventional symbols in the drawings, showing only those specific details that are pertinent to understanding of the various embodiments, examples, aspects, and features of the present disclosure so as not to obscure the disclosure with details that will be readily apparent to those of ordinary skill in the art having the benefit of the description herein.

### DETAILED DESCRIPTION OF THE INVENTION

Portable radios commonly use a slide-in locking mechanism to releasably lock a battery in place along a housing of the portable radio. Portable radios also commonly include a battery connector seal along the housing. The battery slides across the battery connector seal when the battery is being attached or removed from the housing. Repeated sliding of the battery over the battery connector seal during battery attachment and battery removal, however, often causes abrasion to the battery connector seal due to abrasion forces, and may cause the battery connector seal to tear, particularly along a bottom sealing rib of the battery connector seal. Thus, there exists a need for an improved battery connector seal that is able to withstand the repeated abrasion forces imparted by a battery during battery attachment and removal.

One example provides a battery connector seal for a portable communication device. The battery connector seal includes a first sealing rib, a second sealing rib extending from the first sealing rib, a third sealing rib extending from the second sealing rib, and a fourth sealing rib extending from the third sealing rib to the first sealing rib. The first sealing rib, the second sealing rib, the third sealing rib, and the fourth sealing rib together define a central opening. The first sealing rib, the second sealing rib, the third sealing rib, and the fourth sealing rib are positioned to receive a battery sliding across the third sealing rib toward the first sealing rib. The third sealing rib has a non-symmetrical cross-sectional profile.

Further advantages and features consistent with this disclosure will be set forth in the following detailed description, with reference to the figures.

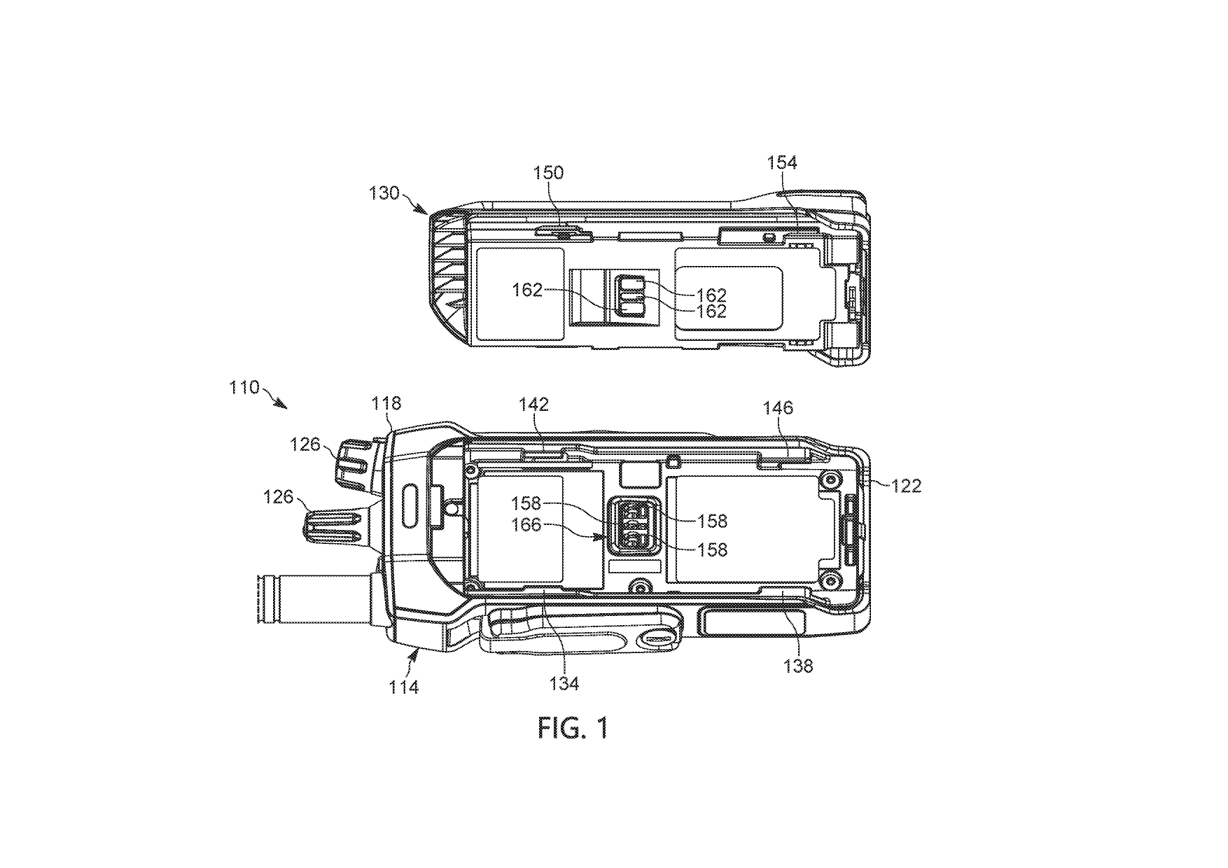

Referring now to the drawings, and in particular FIG. 1, a portable communication device 110 is provided. In the illustrated example, the portable communication device 110 is a portable handheld radio, although in other examples the portable communication device 110 may be a different type of radio, or a different type of portable communication device (e.g., phone, tablet, and the like).

The portable communication device 110 includes a housing 114 that houses at least one component therein (e.g., at least one electronic component). In the illustrated example, the housing 114 includes a top end 118 and a bottom end 122 spaced opposite the top end 118. The portable communication device 110 also includes one or more knobs 126 that extend from the top end 118 of the housing 114, although other examples may not include any knobs 126, or may include other features along the top end 118 (or the bottom end 122, or any portion) of the housing 114.

The portable communication device 110 further includes a battery 130 that provides power to the portable communication device 110, and is removably coupled to the housing 114. In the illustrated example, the battery 130 slides onto the housing 114 to removably attach to the housing 114 and detach from the housing 114.

With continued reference to FIG. 1, in the illustrated example the housing 114 includes a first battery guide rail 134, a second battery guide rail 138, a third battery guide rail 142, and fourth battery guide rail 146. The first battery guide rail 134 is parallel to the third battery guide rail 142, and the second battery guide rail 138 is parallel to the fourth battery guide rail 146. The battery 130 includes a first protrusion 150 sized and shaped to slide under the first battery guide rail 134, and a second protrusion 154 sized and shaped to slide under the second battery guide rail 138. The battery 130 further includes a third protrusion (not shown) sized and shaped to slide under the third battery guide rail 142, and a fourth protrusion (not shown) sized and shaped to slide under the fourth battery guide rail 146. The battery 130 may be attached to the housing 114 by sliding the battery generally along a direction that extends from the bottom end 122 of the housing 114 toward the top end 118 of the housing 114, in a sliding movement. In some examples, the battery and/or the housing 114 additionally includes one or more latches, detents, or other structures that releasably lock the battery 130 in place after the battery 130 slides onto the housing 114. Other examples include other structures, features, and/or arrangements of components (e.g., guide rails, latches, detents, and the like) that permit the battery 130 to be releasably coupled to the housing 114 (including arrangements in which the battery 130 slides onto and/or relative to the housing 114).

With continued reference to FIG. 1, the portable communication device 110 includes at least one connector spring body 158, and the battery 130 includes at least one contact pad 162. The connector spring bodies 158 are sized, shaped, and positioned along the housing 114 such that when the battery 130 is coupled to the housing 114, the spring connector bodies 158 physically engage the contact pads 162, thereby establishing an electrical connection between the battery 130 and an electronic component (e.g., printed circuit board) within the housing 114.

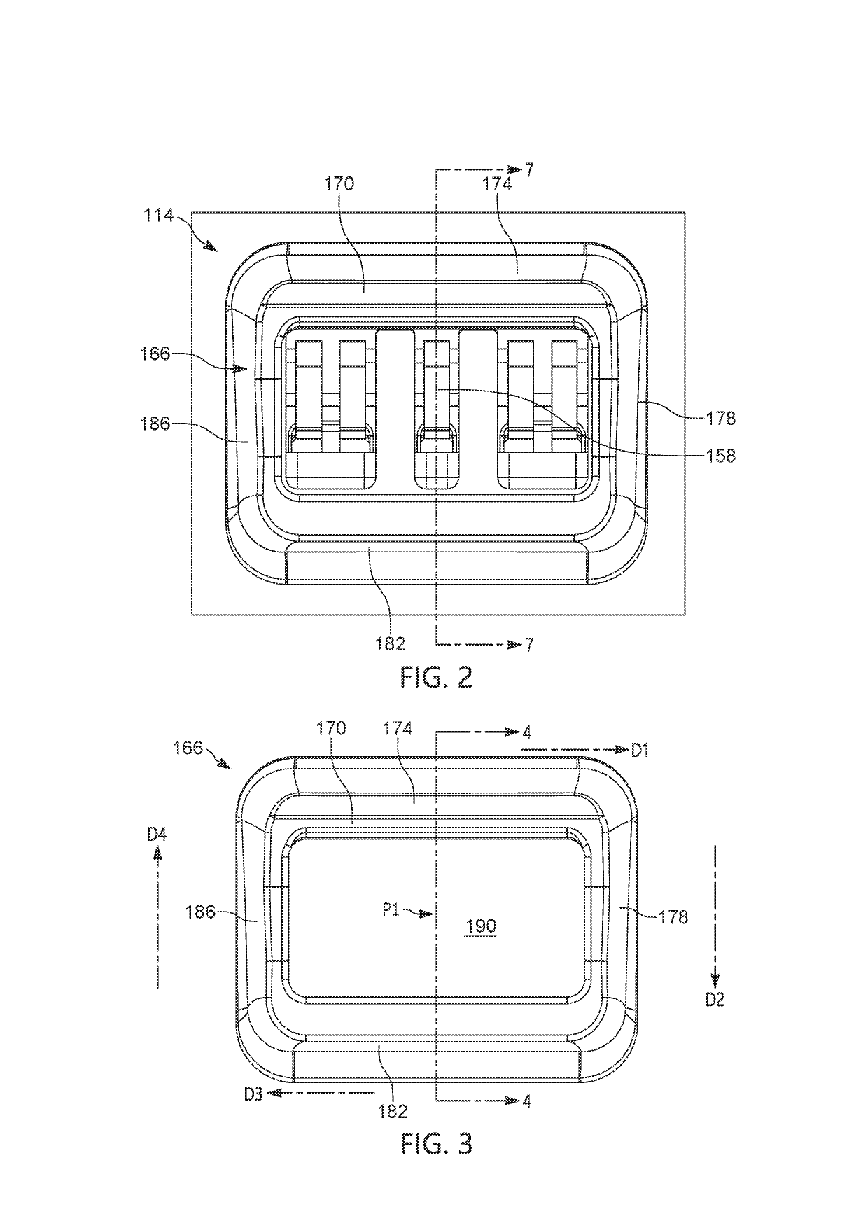

With reference to FIGS. 1 and 2, the portable communication device 110 additionally includes a battery connector seal 166 that extends around (e.g., entirely around) the connector spring bodies 158. When the battery 130 is coupled to the housing 114, the battery connector seal 166 may seal against one or more surfaces along the battery 130, thereby inhibiting or preventing material (e.g., liquid, debris, or other material) from reaching the connector spring bodies 158 or otherwise entering the portable communication device 110.

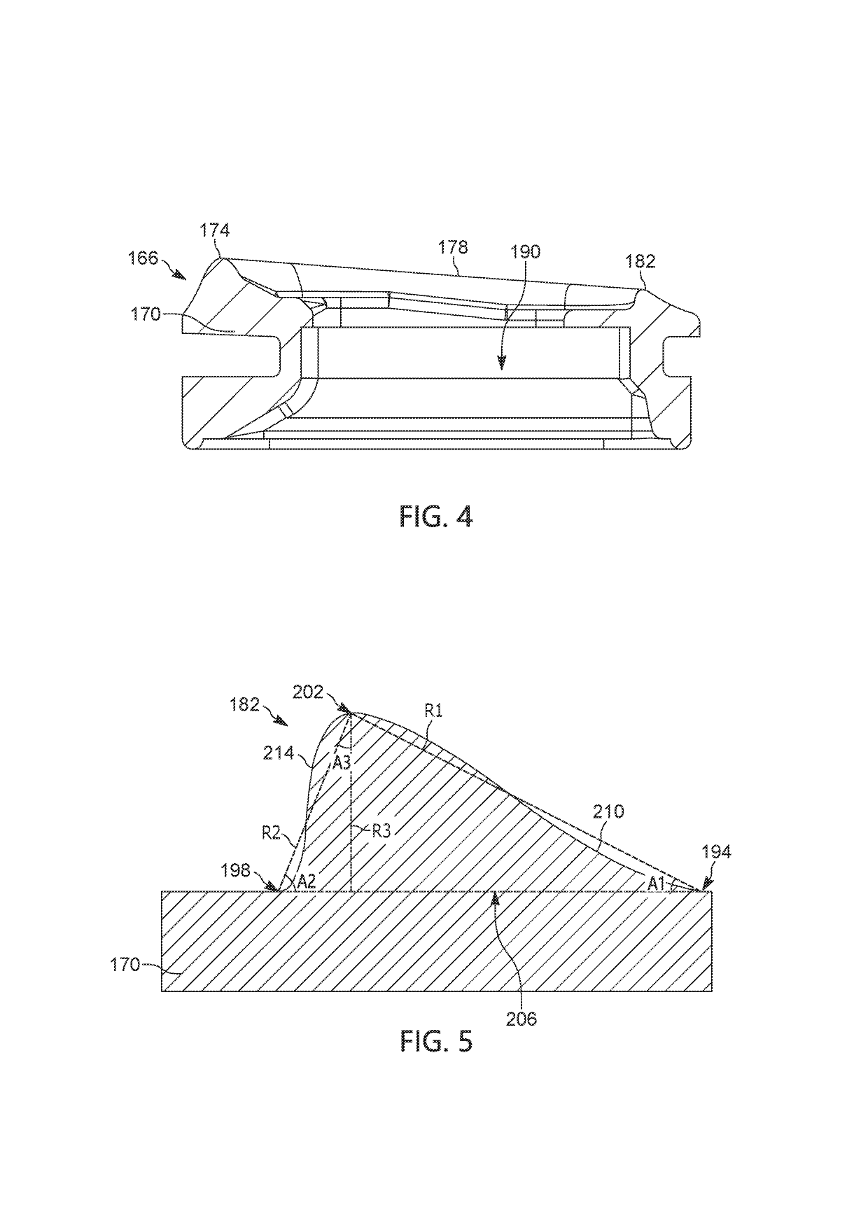

With reference to FIGS. 2-5, the battery connector seal 166 includes a main seal body 170, and at least one sealing rib that protrudes from the main seal body 170. In the illustrated example, the battery connector seal 166 includes a first sealing rib 174 (e.g., an upper seal) that protrudes from the main seal body 170, a second sealing rib 178 (e.g., a right side seal) that protrudes from the main seal body 170 and extends from first sealing rib 174, a third sealing rib 182 (e.g., a bottom seal) that protrudes from the main seal body 170 and extends from the second sealing rib 178, and a fourth sealing rib 186 (e.g., a left side seal) that protrudes from the main seal body 170 and extends from the third sealing rib 182 to the first sealing rib 174. The first sealing rib 174, the second sealing rib 178, the third sealing rib 182, and the fourth sealing rib 186 together define a central opening 190 (FIG. 3). In some examples, the central opening 190 extends as a through opening entirely through the main seal body 170. Overall, the first sealing rib 174, the second sealing rib 178, the third sealing rib 182, and the fourth sealing rib 186 are positioned to receive the battery 130 as the battery slides across the third sealing rib 182 toward the first sealing rib 174.

Other examples include different arrangements, numbers, and shapes of sealing ribs than that illustrated. In the illustrated example, at least a portion of the first sealing rib 174 is parallel to at least a portion of the third sealing rib 182. Additionally, at least a portion of the second sealing rib 178 is parallel to at least a portion of the fourth sealing rib 186. The battery connector seal 166 has a generally rectangular overall shape (e.g., as viewed in FIG. 3). In other examples the battery connector seal 166 may have more than four sealing ribs, or less than four sealing ribs, or may have sealing ribs that are not arranged in a generally rectangular shape as seen in FIG. 3.

With reference to FIGS. 3-5, the third sealing rib 182 has a non-symmetrical cross-sectional profile. In the illustrated example, the non-symmetrical cross-sectional profile is a shark fin profile. In some examples, each of the first sealing rib 174, the second sealing rib 178, and the fourth sealing rib 186 has a symmetrical cross-sectional profile, such that only one of the sealing ribs (e.g., the third sealing rib 182) has the non-symmetrical cross-sectional profile. In other examples, one or more of the other sealing ribs (e.g., the first sealing rib 174, the second sealing rib 178, and/or the fourth sealing rib 186) also has a non-symmetrical cross-sectional profile.

With reference to FIG. 3, the non-symmetrical cross-sectional profile of the third sealing rib 182 may be taken, for example, along a plane P1 that extends through the third sealing rib 182, the central opening 190, and the first sealing rib 174. In the illustrated example, the first sealing rib 174 extends along a first direction D1, the second sealing rib 178 extends along a second direction D2, the third sealing rib 182 extends along a third direction D3, and the fourth sealing rib 186 extends along a fourth direction D4. The first direction D1 is parallel to the third direction D3, and the plane P1 is perpendicular to each of the first direction D1 and the third direction D3.

With reference to FIG. 5, in the illustrated example the non-symmetrical cross-sectional profile of the third sealing rib 182 includes a first rib base point 194, a second rib base point 198, and a rib apex point 202. The first rib base point 194 and the second rib base point 198 may be defined as points, between which, the third sealing rib 182 protrudes away from the main seal body 170. As illustrated in FIG. 5, a base line 206 extends between the first rib base point 194 and the second rib base point 198, and defines a lower boundary of the third sealing rib 182. The rib apex point 202 defines a peak of the third sealing rib 182. The rib apex point 202 is spaced apart from the base line 206 (and for example is a point farthest away from the base line 206 along a direction perpendicular to the base line 206). As illustrated in FIG. 5, the rib apex point 202 is positioned closer to the second rib base point 198 than the first rib base point 194.

With continued reference to FIG. 5, in the illustrated example the non-symmetrical cross-sectional profile additionally includes a first boundary line 210 extending between the first rib base point 194 and the rib apex point 202, and defining a first portion of an exterior of the third sealing rib 182. The cross-sectional profile additionally includes a second boundary line 214 extending between the rib apex point 202 and the second rib base point 198 and defining a second portion of the exterior of the third sealing rib 182.

In some examples, an angle between the base line 206 and the first boundary line 210 is greater than 0 degrees and less than 90 degrees (e.g., less than or equal to 30 degrees, between 1 – 30 degrees, between 10 – 30 degrees, between 20 – 30 degrees, or other values and ranges of values). In some examples, an angle between the base line 206 and the second boundary line 214 is greater than 0 degrees and less than 120 degrees (e.g., greater than 30 degrees but less than 120 degrees, greater than 30 degrees but less than or equal to 90 degrees, or other values and ranges of values). Other examples include different values and ranges of values (including values greater than 120 degrees).

As illustrated in FIG. 5, at least a portion of the first boundary line 210 and/or at least a portion of the second boundary line 214 may be curved. For example, at least a portion of the first boundary line 210 may have a convex curvature, and/or at least a portion of the first boundary line 210 may have a concave curvature. Similarly, at least a portion of the second boundary line 214 may have a convex curvature, and/or at least a portion of the second boundary line 214 may have a concave curvature. Accordingly, the respective angles between the base line 206 and the first and second boundary lines 210, 214 may vary depending upon the points chosen along the first and second boundary lines 210, 214 for measurement. In some examples, the angle between the base line 206 and the first boundary line 210 may be an angle between the base line 206 and a line drawn tangent to a selected point along the first boundary line 210. Similarly, in some examples the angle between the base line 206 and the second boundary line 214 may be an angle between the base line 206 and a line drawn tangent to a selected point along the second boundary line 214.

With continued reference to FIG. 5, in some examples an angle A1 may be measured instead between the base line 206 and a first reference line R1 that extends linearly from the rib apex point 202 to the first rib base point 194. An angle A2 may similarly be measured, for example, between the base line 206 and a second reference line R2 that extends linearly from the rib apex point 202 to the second rib base point 198. The values and ranges for angles A1 and A2 may be the same as the values and ranges discussed above. For example, the angle A1 may be greater than 0 degrees and less than 90 degrees (e.g., less than or equal to 30 degrees, between 1 – 30 degrees, between 10 – 30 degrees, between 20 – 30 degrees, or other values and ranges of values. In some examples, the angle A2 may be greater than 0 degrees and less than 120 degrees (e.g., greater than 30 degrees but less than 120 degrees, greater than 30 degrees but less than or equal to 90 degrees, or other values and ranges of values).

With continued reference to FIG. 5, in some examples a third reference line R3 extends from the rib apex point 202 to the base line 206. The third reference line R3 extends perpendicular to the base line 206. In some examples, an angle between the third reference line R3 and the and the second boundary line 214 (or between the third reference line R3 and a line drawn tangent to a point along the second boundary line 214) may be greater than or equal to 0 degrees and less than 60 degrees (e.g., between 0 – 20 degrees, between 5-20 degrees, between 0 – 40 degrees, between 0 – 60 degrees, or other values and ranges of values, including values greater than 60 degrees).

As illustrated in FIG. 5, in some examples an angle A3 may be measured instead between the third reference line R3 and the second reference line R2. In some examples, the angle A3 may be greater than or equal to 0 degrees and less than 60 degrees (e.g., between 0 – 20 degrees, between 5-20 degrees, between 0 – 40 degrees, between 0 – 60 degrees, or other values and ranges of values, including values greater than 60 degrees).

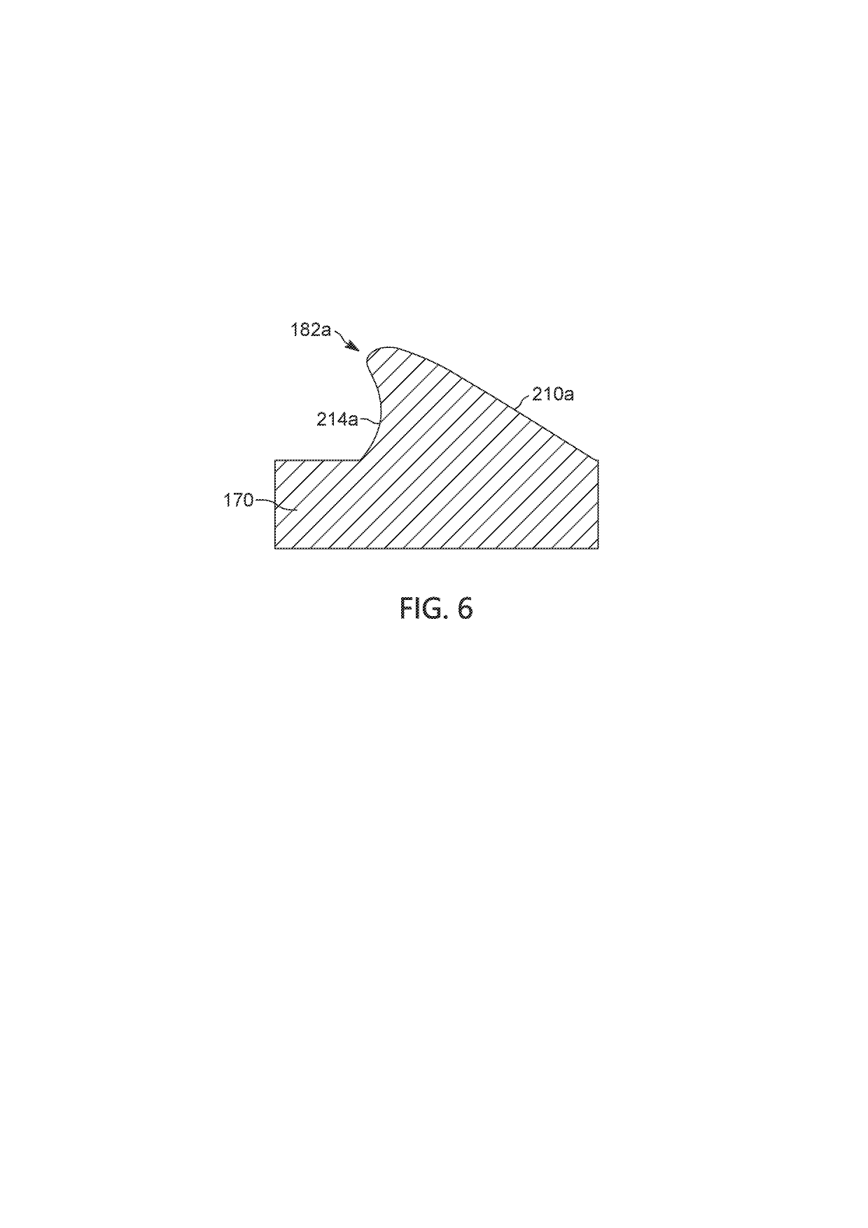

With reference to FIG. 6, the cross-sectional profile of the third sealing rib 182 may take on other shapes than that illustrated in FIG. 5. For example, FIG. 6 illustrates a third sealing rib 182a having a different profile than the third sealing rib 182 in FIG. 5. The third sealing rib 182a still has a shark fin profile, similar to FIG. 5, but as seen in FIG. 6, the third sealing rib 182a has an undercut along a posterior side, such that a first boundary line 210a is similar to the first boundary line 210 in FIG. 5, but a second boundary line 214a has a much more pronounced, concave shape as compared with the second boundary line 214 in FIG. 5. Other examples include various other shapes and profiles than that illustrated.

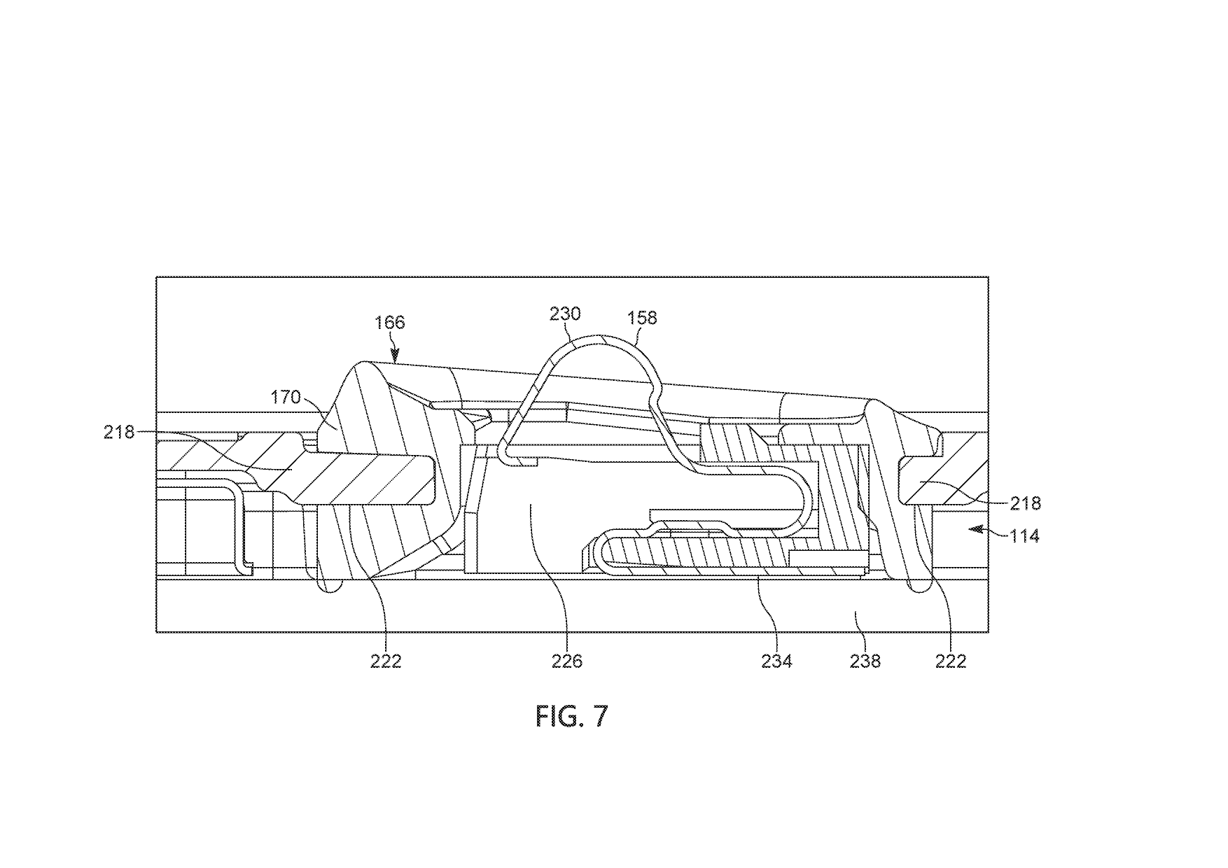

With reference to FIG. 7, in some examples the housing 114 of the portable communication device 110 defines a chassis 218. The main seal body 170 of the battery connector seal 166 includes a recess 222 that is sized and shaped to receive a portion of the chassis 218. The recess 222 may extend, for example, entirely around the main seal body 170, although in other examples the recess 222 may extend only partially around the main seal body 170. Similarly, the portion of the chassis 218 may extend, for example, entirely around the main seal body 170, although in other examples the portion of the chassis may extend only partially around the main seal body 170. In yet other examples, the housing 114 of the portable communication device 110 does not include a portion of a chassis that extends into a recess in the main seal body 170.

With continued reference to FIG. 7, in some examples the portable communication device 10 includes a connector spring body 226 positioned within the central opening 190 of the battery connector seal 166. As illustrated in FIG. 7, at least one of the connector spring bodies 158 is coupled to the connector spring body 226. The connector spring body 158 includes a first end 230, and a second (e.g., opposite) end 234. The first end 230 protrudes out of the central opening 190.

With continued reference to FIG. 7, in some examples the portable communication device 110 further includes a printed circuit board 238. The second end 234 of the connector spring body 158 is coupled to the printed circuit board 238. Additionally, and as illustrated in FIG. 7, the main seal body 170 of the battery connector seal 166 is also coupled (e.g., sealed) to the printed circuit board 238. Other examples include other arrangements of connector springs, connector spring bodies, printed circuit boards, or other electronic components associated with the battery connector seal 166.

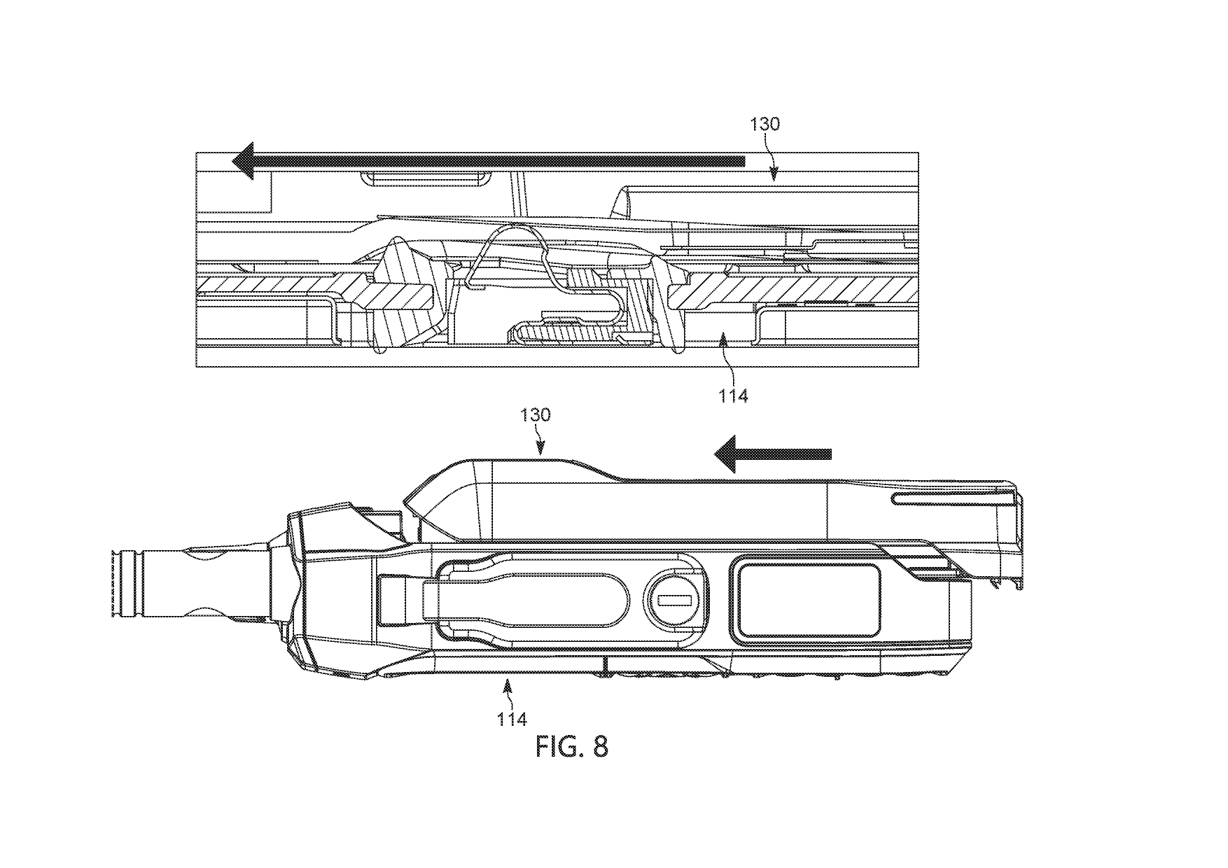

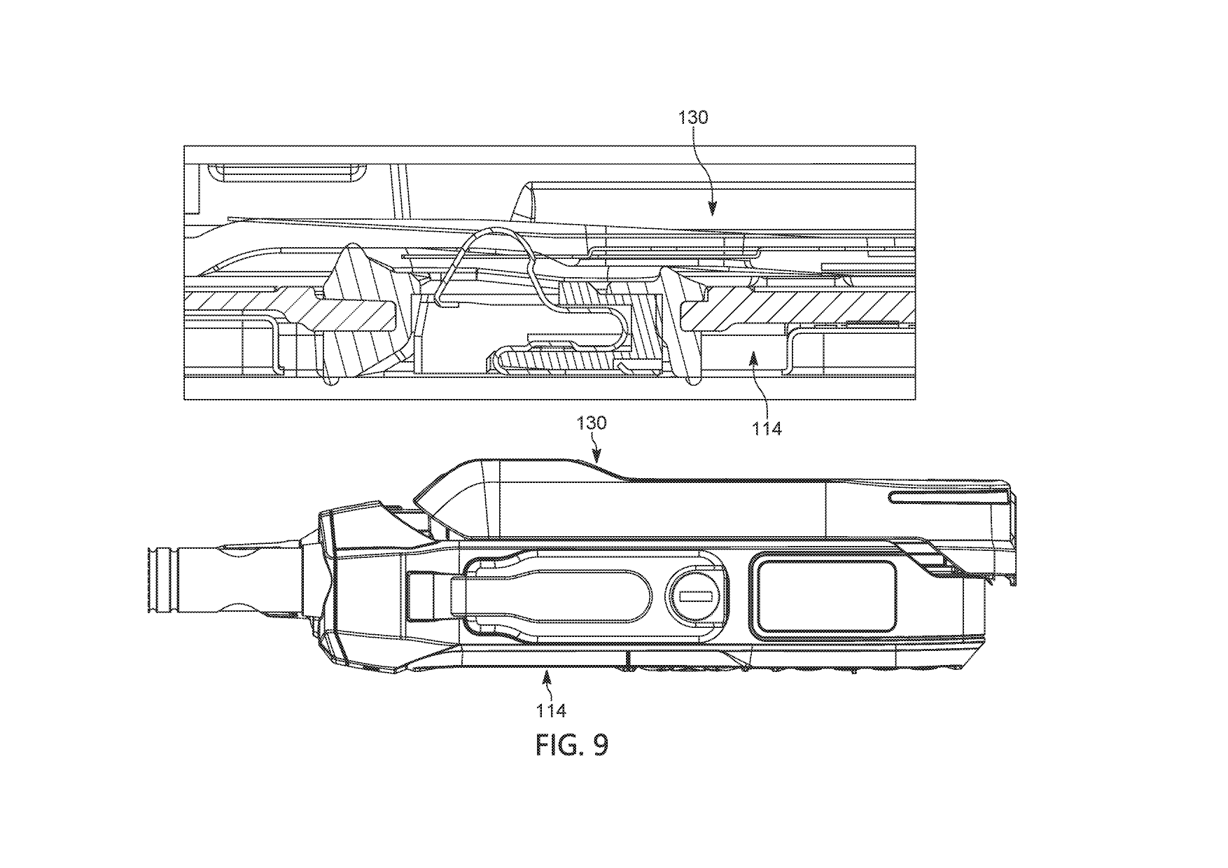

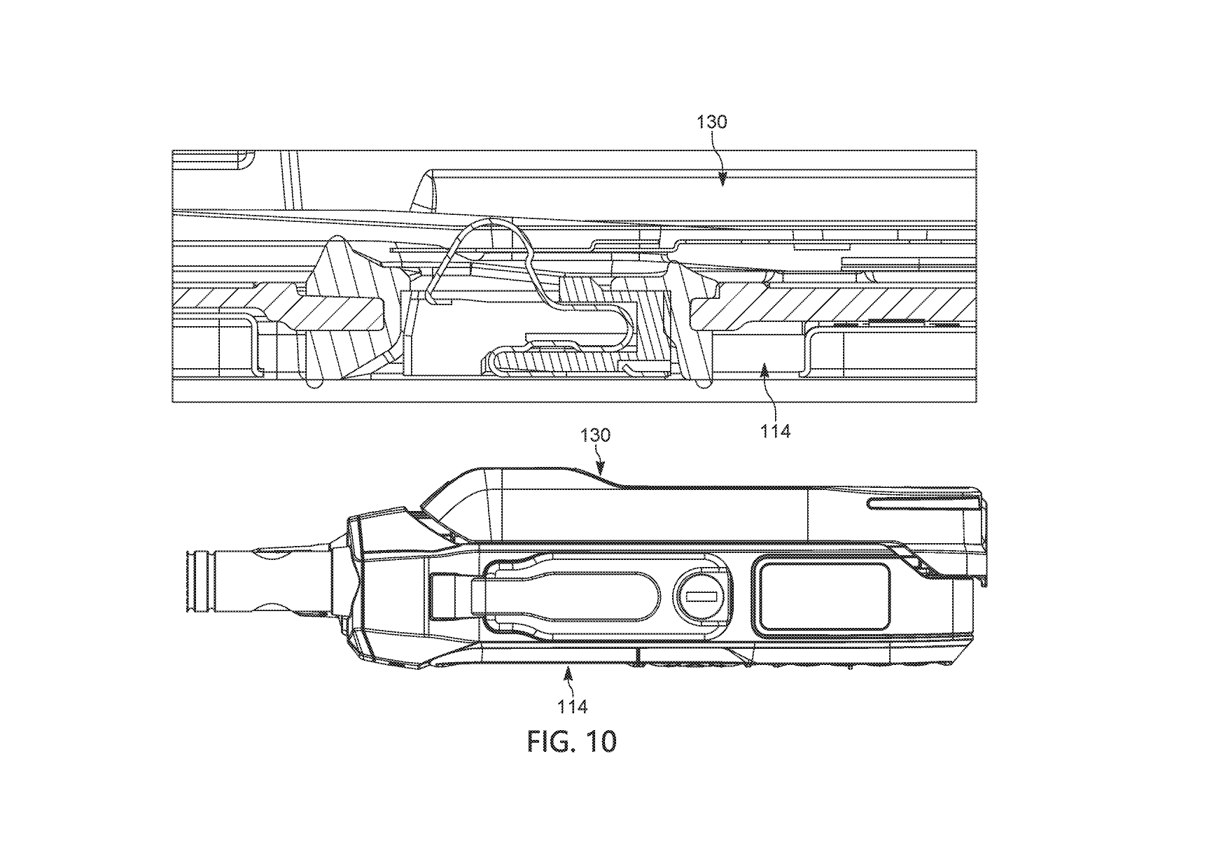

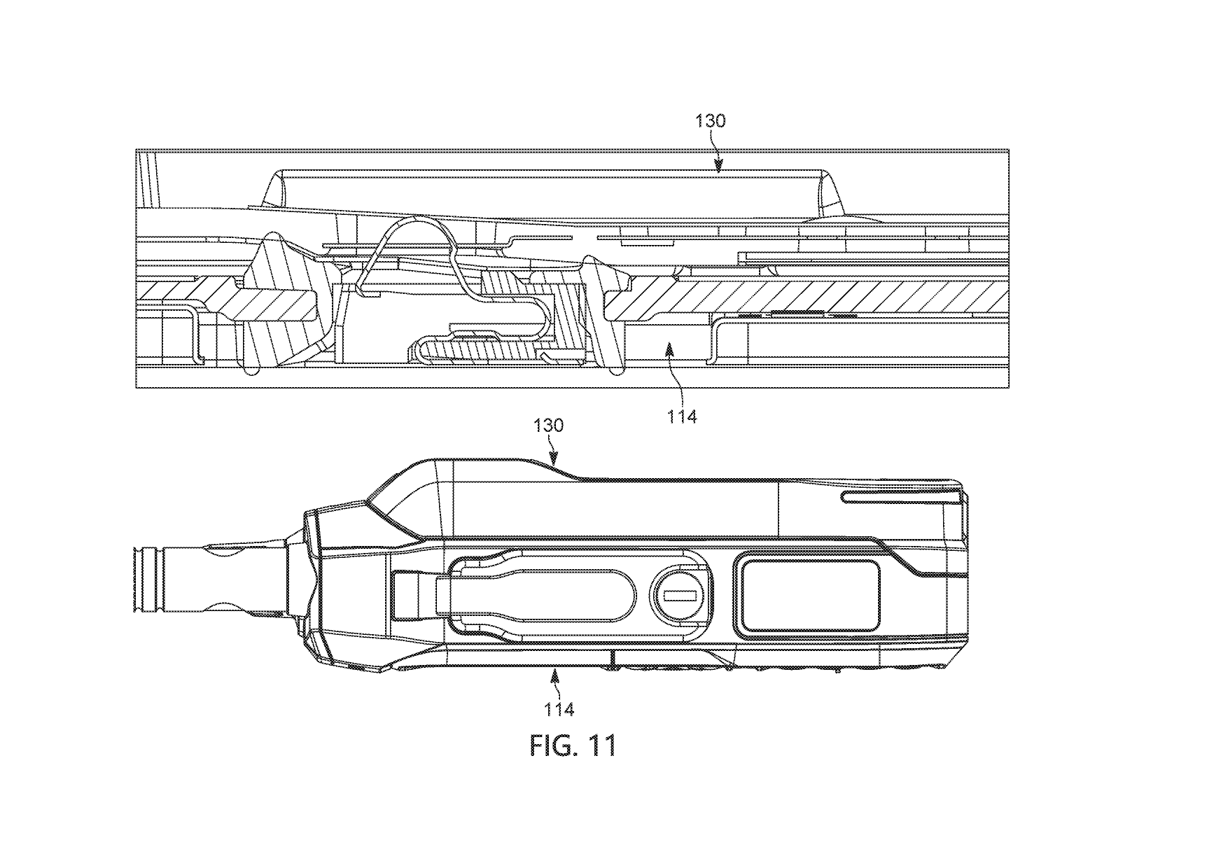

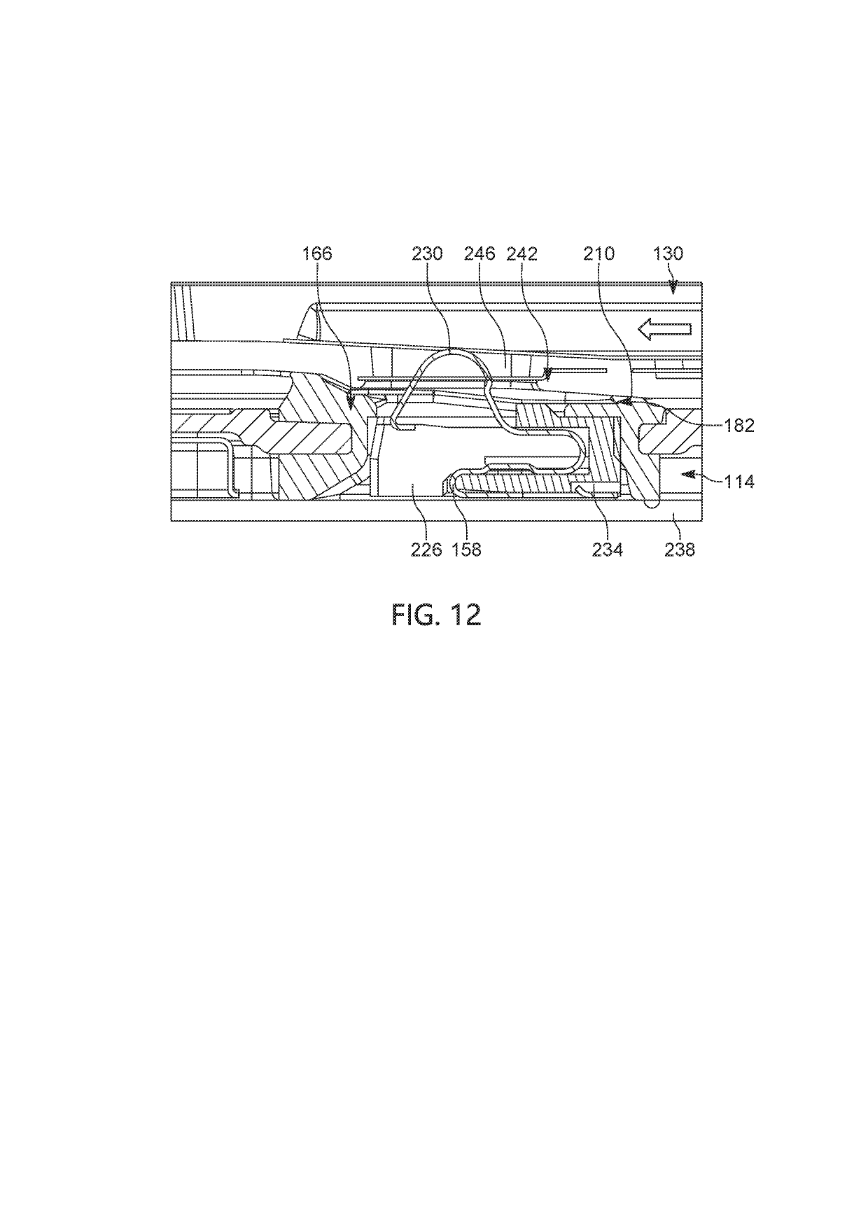

With reference to FIGS. 8-12, during attachment of the battery 130 to the housing 114, at least a portion of the battery 130 slides across the battery connector seal 166. In the illustrated example, the battery 130 includes a casing (e.g., plastic casing) having a leading edge 242 (FIG. 12) that defines an opening 246 to receive the first end 230 of the connector spring body 158, such that the first end 230 may engage one of the contact pads 162 (FIG. 1). In some examples, the battery 130 includes over-molded sheet metal at or near the opening 246. As the battery 130 slides (e.g., via the first battery guide rail 134, the second battery guide rail 138, the third battery guide rail 142, and/or the fourth battery guide rail 146), the leading edge 242 engages and presses against the third sealing rib 182 of the battery connector seal 166.

With continued reference to FIGS. 8-12, as the leading edge 242 presses against the third sealing rib 182, the third sealing rib 182 flexes (due to the non-symmetrical cross-sectional profile) and is compressed and/or folds over. As illustrated in FIG. 12, once the battery 130 is attached to the housing 114, the battery 130 remains pressed against the third sealing rib 182 (e.g., against the first boundary line 210 of the third sealing rib 182), maintaining the third sealing rib 182 in its flexed state. To remove the battery 130 from the housing 114, the battery 130 slides in an opposite direction (i.e., to the right in FIG. 12), and slides back over the third sealing rib 182 until the third sealing rib 182 is no longer contacted by the battery 130, and the third sealing rib 182 may return to its natural configuration (FIG. 5).

In the foregoing specification, specific embodiments, examples, aspects, and features have been described. However, one of ordinary skill in the art appreciates that various modifications and changes can be made without departing from the scope of the subject matter as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a,” “has …a,” “includes …a,” or “contains …a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled,” “coupling,” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples and embodiments for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A battery connector seal for a portable communication device, the battery connector seal comprising:
a first sealing rib;
a second sealing rib extending from the first sealing rib;
a third sealing rib extending from the second sealing rib; and
a fourth sealing rib extending from the third sealing rib to the first sealing rib;
wherein the first sealing rib, the second sealing rib, the third sealing rib, and the fourth sealing rib together define a central opening, and wherein the first sealing rib, the second sealing rib, the third sealing rib, and the fourth sealing rib are positioned to receive a battery sliding across the third sealing rib toward the first sealing rib; and
wherein the third sealing rib has a non-symmetrical cross-sectional profile.

2. The battery connector seal of claim 1, wherein the non-symmetrical cross-sectional profile is a shark fin profile.

3. The battery connector seal of claim 1, wherein the first sealing rib is an upper seal, wherein the second sealing rib is a right side seal, wherein the third sealing rib is a bottom seal, wherein the fourth sealing rib is a left side seal, wherein at least a portion of the first sealing rib extends parallel to at least a portion of the third sealing rib, and wherein at least a portion of the second sealing rib extends parallel to at least a portion of the fourth sealing rib.

4. The battery connector seal of claim 1, wherein the first sealing rib has a symmetrical cross-sectional profile, wherein the second sealing rib has a symmetrical cross-sectional profile, and wherein the fourth sealing rib has a symmetrical cross-sectional profile.

5. The battery connector seal of claim 1, further comprising a main seal body, wherein the first sealing rib protrudes from the main seal body, wherein the second sealing rib protrudes from the main seal body, wherein the third sealing rib protrudes from the main seal body, and wherein the fourth sealing rib protrudes from the main seal body.

6. The battery connector seal of claim 1, wherein the non-symmetrical cross-sectional profile is taken along a plane that extends through the third sealing rib, the central opening, and the first sealing rib.

7. The battery connector seal of claim 6, wherein the first sealing rib extends along a first direction, wherein the second sealing rib extends along a second direction, wherein the third sealing rib extends along a third direction, and wherein the fourth sealing rib extends along a fourth direction, wherein the first direction is parallel to the third direction, and wherein the plane is perpendicular to each of the first direction and the third direction.

8. The battery connector seal of claim 1, wherein the non-symmetrical cross-sectional profile includes a first rib base point, a second rib base point, and a rib apex point, wherein a base line extending between the first rib base point and the second rib base point defines a lower boundary of the third sealing rib, wherein the rib apex point defines a peak of the third sealing rib, wherein the rib apex point is spaced apart from the lower boundary, and wherein the rib apex point is positioned closer to the second rib base point than the first rib base point.

9. The battery connector seal of claim 8, wherein the non-symmetrical cross-sectional profile includes a first boundary line extending between the first rib base point and the rib apex point and defining a first portion of an exterior of the third sealing rib, and a second boundary line extending between the rib apex point and the second rib base point and defining a second portion of the exterior of the third sealing rib.

10. The battery connector seal of claim 9, wherein an angle between the base line and the first boundary line is between 20 – 30 degrees.

11. The battery connector seal of claim 9, wherein an angle between the base line and the second boundary line is greater than 30 degrees and less than 120 degrees.

12. The battery connector seal of claim 9, wherein a reference line extends from the rib apex point to the base line, wherein the reference line extends perpendicular to the base line, and wherein an angle between the reference line and the second boundary line is between 0 – 60 degrees.

13. The battery connector seal of claim 9, wherein at least a portion of the first boundary line is curved.

14. The battery connector seal of claim 9, wherein at least a portion of the second boundary line is curved.

15. The battery connector seal of claim 9, wherein at least a portion of the first boundary line has a convex curvature, and wherein at least a portion of the second boundary line has a concave curvature.

16. A portable communication device comprising:
a housing defining a chassis; and
the battery connector seal of claim 1 coupled to the chassis.

17. The portable communication device of claim 16, wherein the battery connector seal includes a main seal body, wherein the third sealing rib protrudes from the main seal body, and wherein the main seal body includes a recess sized and shaped to receive a portion of the chassis.

18. The portable communication device of claim 17, further comprising a connector spring body positioned within the central opening, and a connector spring coupled to the connector spring body, wherein the connector spring includes a first end that protrudes out of the central opening.

19. The portable communication device of claim 18, further comprising a printed circuit board, wherein a second, opposite end of the connector spring is coupled to the printed circuit board, and wherein the main seal body of the battery connector seal is coupled to the printed circuit board.

20. The portable communication device of claim 19, further comprising the battery, wherein the battery includes a leading edge that defines an opening to receive the first end of the connector spring, wherein the non-symmetrical cross-sectional profile includes a first rib base point, a second rib base point, and a rib apex point, wherein a base line extending between the first rib base point and the second rib base point defines a lower boundary of the third sealing rib, wherein the housing of the portable communication device includes a guide rail to guide a sliding movement of the battery across the battery connector seal, and wherein the battery is configured to slide along a direction that is parallel to the base line of the third sealing rib, such that the battery moves along a direction that extends from the third sealing rib to the first sealing rib, and such that the leading edge of the battery engages and presses against the third sealing rib.
